(19) United States
(12) Patent Application Publication
(10) Pub. No.: US 2022/0124166 A1
(43) Pub. Date: Apr. 21, 2022

(54) SYSTEM AND METHOD FOR MANAGEMENT OF ONLINE INTELLIGENCE PERSONAS

(71) Applicant: D3 Intelligence LLC, Phoenix, AZ (US)

(72) Inventors: Brian Mohr, Phoenix, AZ (US); Walter Cook, Phoenix, AZ (US)

(21) Appl. No.: 17/507,248

(22) Filed: Oct. 21, 2021

Related U.S. Application Data
(60) Provisional application No. 63/094,649, filed on Oct. 21, 2020.

(51) Int. Cl. H04L 29/08; G06Q 10/06

(52) U.S. Cl. CPC H04L 67/306; G06Q 10/06

(57) ABSTRACT

Systems and methods for management of online intelligence personas according to various aspects of the present technology may comprise a persona module configured to create one or more maps between a plurality of intelligence agents, online personas managed by those agents, known contacts of managed personas, targeted intelligence assets, and known methods of communication. The persona module is configured to present a visual depiction of stored data providing a more efficient method of accessing stored data and presenting commonalities between unique persona profiles and associated data.

### CROSS-REFERENCES TO RELATED APPLICATIONS

This application claims the benefit of U.S. Provisional Patent Application No. 63/094,649, filed Oct. 21, 2020, and incorporates the disclosure of the application by reference.

### BACKGROUND OF THE TECHNOLOGY

Intelligence agents that manage online personas lack an efficient way of managing individual personas and often rely on manual tracking in a spreadsheet, manually generated documents, or password management tools. This creates an inconsistent system that is not easily managed, traceable, auditable, and does not provide for investigation continuity if a given intelligence agent is unexpectedly removed from service. These methods also do not allow for the sharing of information between intelligence agents or agencies.

The result is that information pertaining to online personas is not captured in an organized or easily transferrable manner creating inefficiencies and an inability to effectively track intelligence sources over time. Management of intelligence personas becomes difficult because necessary information is unable to be easily accessed and historical data becomes lost. More importantly, key relationships between distinct personas and any intelligence targets or assets are not readily available to intelligence agents or those managing the personas.

### SUMMARY OF THE TECHNOLOGY

Systems and methods for management of online intelligence personas according to various aspects of the present technology may comprise a persona module configured to create one or more maps between a plurality of intelligence agents, online personas managed by those agents, known contacts of managed personas, targeted intelligence assets, and known methods of communication. The persona module is configured to present a visual depiction of stored data providing a more efficient method of accessing stored data and presenting commonalities between unique persona profiles and associated data.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 representatively illustrates a block diagram of a persona management system in accordance with an exemplary embodiment of the present technology;

FIG. 2 representatively illustrates an entry field for a new persona in accordance with an exemplary embodiment of the present technology;

FIG. 3 representatively illustrates a persona management screen in accordance with an exemplary embodiment of the present technology;

FIG. 4 representatively illustrates a new platform entry field in accordance with an exemplary embodiment of the present technology;

FIG. 5 representatively illustrates a platform management screen in accordance with an exemplary embodiment of the present technology;

FIG. 6 representatively illustrates a target management screen in accordance with an exemplary embodiment of the present technology; and

FIG. 7 representatively illustrates a comment tracking screen in accordance with an exemplary embodiment of the present technology.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of computing platforms, memory storage systems, and communication networks, which may carry out a variety of operations suited to processing various types of information. In addition, the technology described is merely one exemplary application for the invention. Further, the present technology may employ any number of conventional techniques for data input, storage, retrieval, reporting, presenting, or otherwise managing data.

Systems and methods for management of online intelligence persona according to various aspects of the present technology may operate in conjunction with any type of computing system, application server, data storage system, or the like. Various representative implementations of the present technology may be applied to any system for storing uniquely identifying information associated with human intelligence (HUMINT) operations such as persona names and aliases, passwords, corresponding background or biographic information for created personas, names of intelligence assets or targets, intelligence details of identified targets, collections of sources, and other related information for allowing a user to manage and operate an online persona.

The present technology may involve multiple programs, functions, computing devices (such as client computers and/or servers), and the like. While the exemplary embodiments are described in conjunction with conventional computing devices, the various elements and processes may be implemented in hardware, software, or any combination of hardware, software, and other systems. Further, the present technology may employ any number of conventional techniques for generating and/or analyzing collected information, interfacing a computing device to a remote network, transmitting and/or receiving data, providing a user interface, communicating information, interfacing with a user, detecting and/or analyzing input to a computing device, gathering data, and the like.

The system may be configured to communicate over any suitable communication network (e.g., wirelessly through wireless protocols, the internet, cellular, LAN, or other networks) with one or more other user devices. A “user device” refers to any device having a central processing unit (“CPU”) capable of performing computing functions and having the ability to communicate with other devices either through a wireless communication system or a wired communication system such as: smartphones, tablet computers, smart watches, laptop computers, desktop computers, or other similar devices.

Further, databases, systems, and/or components of the present technology may comprise any combination of databases, systems, and/or components at a single location or at multiple locations. Each database, system, and/or component of the present technology may comprise any suitable security features, such as one or more firewalls, access codes, encryption, de-encryption, compression, decompression, and/or the like. Systems and methods according to the present technology may comprise one or more databases configured to store data according to the present technology. In some embodiments, data may be shared and/or linked among the various databases and servers. The one or more databases may be implemented using database schemes such as IBM DB2, Oracle, MySQL, and/or Microsoft SQL Server, or any other database scheme, whether now known or later developed. Transferring data to and from the one or more databases may be accomplished using a communicative coupling, for example a network connection to the Internet or a local area network (LAN).

The present technology may be embodied as a method, a system, a device, and/or a computer program product. Accordingly, the present technology may take the form of an entirely software embodiment, an entirely hardware embodiment, or an embodiment combining aspects of both software and hardware. Furthermore, the present technology may take the form of a set of instructions, such as a computer program product for causing a processor and/or computing device to perform a desired function, stored on a non-transitory computer-readable storage medium having computer-readable program code embodied in the storage medium. Any suitable computer-readable storage medium may be utilized, including, but not limited to, hard disk drive, CD-ROM, optical storage devices, magnetic storage devices, solid-state devices, USB memory devices, any appropriate volatile or non-volatile memory system, and the like or any combination thereof. The present technology may take the form of a downloadable and/or cloud-based non-downloadable computer program product, and/or a software as a service (SAAS) product that is accessed by the user device over a network.

Software and/or software elements according to various aspects of the present technology may be implemented with any programming, scripting, or computer language or standard, such as, for example, AJAX, C, C++, Java, JavaScript, COBOL, assembly, PERL, eXtensible Markup Language (XML), PHP, CSS, HL7, GNU Mathematical Programming Language (GMPL), etc., or any other programming and/or scripting language, whether now known or later developed. Further, the present technology may be used in conjunction with a computing device running any operating system such as any version of Windows, MacOS, OS/2, BeOS, Linux, UNIX, Android, iOS, or any other operating system, whether now known or later developed, and the present technology may be used in conjunction with any software application operating on such a computing device.

In addition, the present technology may employ any number of conventional techniques for data transmission, signaling, data processing, network control, and the like. Computing devices according to various aspects of the present technology may communicate with each other by one or more telecommunication networks. The telecommunication network may comprise a collection of terminal nodes, links, and any intermediate nodes which are connected to enable communication (including transfer of data) at a distance between the terminal nodes. In some embodiments, a terminal node may comprise a computing device. The telecommunication network may comprise any suitable communication system, such as the Internet, an intranet, an extranet, WAN, LAN, Bluetooth, satellite communications, cellular radio network, wireless network, telephone network, cable network, and the like. Moreover, computing devices according to various aspects of the present technology may communicate over the telecommunication network using TCP/IP, HTTP, HTTPS, FTP, IPX, AppleTalk, IP-6, NetBIOS, OSI, and/or any number of existing or future protocols. The telecommunication network may be simply referred to as a network.

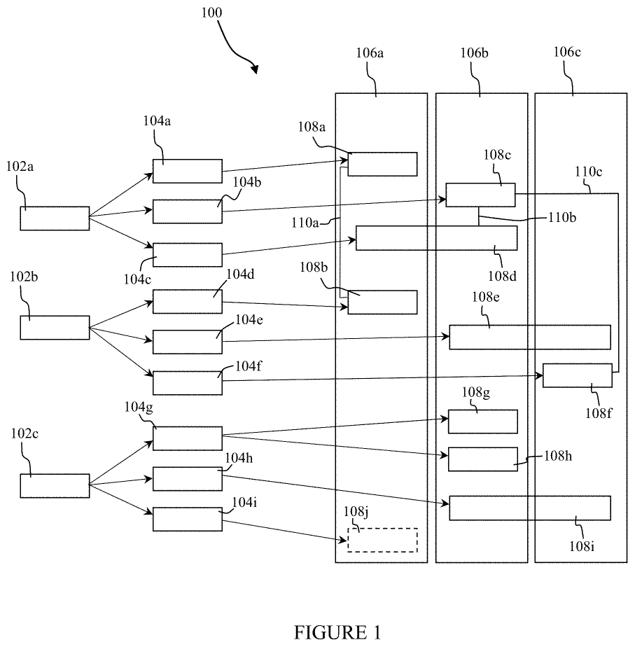

Referring to FIG. 1, the system may comprise a persona management module 100 accessible by one or more user devices, wherein the persona management module 100 is configured to track, store, and report a set of persona profile data for a plurality of created personas (puppets) 104a-104i that are controlled by a plurality of intelligence operators 102a-102c for tracking multiple intelligence targets 108a-108i across multiple online platforms 106a-106c. Each persona represents a fictitious person created to impersonate a real human in one or more online communication forums or social media platforms. A single intelligence operator may be used to manage or control a given persona in each online communication forum or social media platform the persona is active on and then record or otherwise preserve interactions or conversations the persona has with real-life persons (e.g., intelligence targets) on these forums and platforms.

Persona profile data may comprise any suitable information or details necessary to create a unique online persona such as personal and family biographic details, residence information, pictures of the persona, languages used by the persona, aliases, forums or social media platforms used, logins and passwords, and any other suitable personally identifiable or generic information commonly associated with a person having an online presence. Persona profile data may also comprise details on intelligence targets that a given persona interacts with online.

The persona management module 100 may be configured to automatically generate one or more mappings of the stored persona profile data for all stored personas to provide a visual representation of relationships between created personas 104, intelligence targets 108, and the corresponding platforms 106 used to gather intelligence information on or from the intelligence targets 108. The mapping process may create links or commonalities 110 between various personas such as intelligence targets 108, platforms 106, or any other suitable source of information that can be leveraged by the system during planning, assigning, and reporting phases. For example, the persona management module 100 may use the mapping process to generate a visual depiction of saved data from the stored persona profiles to visually indicate that a given first intelligence target 108a is a known associate of a second intelligence target 108b on the same platform 106a. This first link 110a may be displayed in a manner that quickly identifies which personas 104 and which corresponding intelligence operator 102 are connected to each intelligence target 108.

Additional mappings may be generated by the system for any suitable purpose such as to preserve historical knowledge of created personas 104; improve persona management; monitor established relationships between personas 104 and intelligence targets 108; evaluate performance of a given persona 104; assist with the transferring of persona management from a first intelligence operator 102a to a second intelligence operator 102b if necessary; or any other desired factors or elements. For example, in one embodiment, the persona management module 100 may be configured to select a mapping that provides a visual historical depiction of conversations that a given persona 104 has had with a selected intelligence target 108 over a specified period of time. The mapping may also be able to provide a historical account of group conversations between any number of selected personas 104 and intelligence targets 108.

These mappings may display the conversations in any desired format to assist users to understand the conversations more quickly. For example, conversations may be displayed in a manner that replicates how a text or direct message conversation would be displayed on a device such as a mobile phone or tablet computing device. The mapping may also be able to display the conversation from a selected point of view. For example, the persona management module 100 may include an option to have the conversation displayed from a persona's device or an intelligence target's device. Displaying the conversation in this manner would help someone who was not part of the original conversation more quickly understand the conversation and the parties involved than if they were to simply read a transcript of the conversation created from stored data.

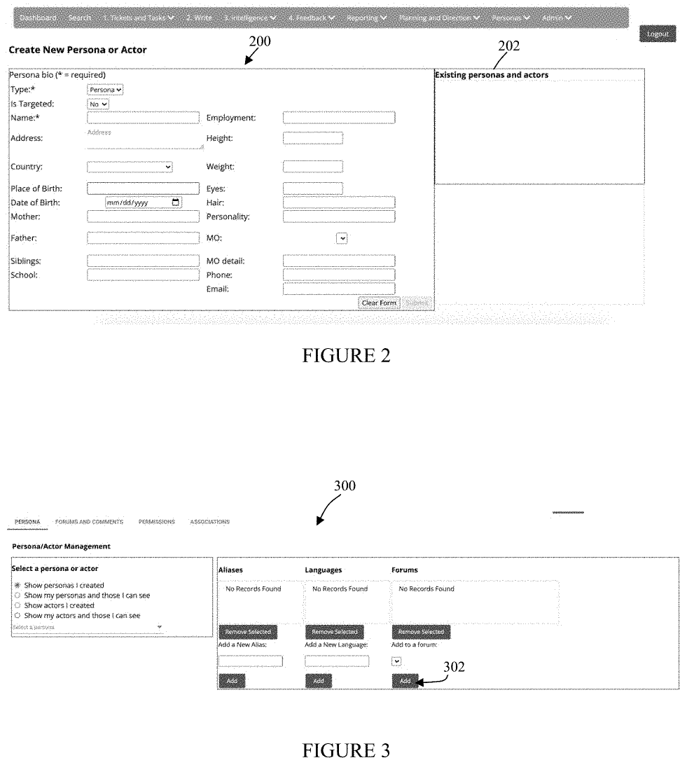

Referring now to FIG. 2, the system may allow an intelligence operator 102 or other user to create a new persona along with the corresponding persona profile data. The new persona and corresponding persona profile data is then stored in the persona management module 100. For example, the persona management module 100 may display to the user device a persona form 200 configured to receive data used to create the persona 104. The data may comprise any information that is commonly associated with personally identifiable information of a real person such as: name, address, biometric data, names of family members, place and date of birth, photos, and contact information. This data may be generated by the intelligence operator 102 or it may be provided to the intelligence operator 102 by a persona generator or other source. The intelligence operator 102 may then use this persona biographic data to create an online presence on one or more online platforms 106 to gather information from one or more intelligence targets 108. The persona management module 100 may also display a list 202 of other existing personas 104 already saved in the system.

Any given intelligence operator 102 may operate multiple personas 104 and therefore be required to manage individual personas simultaneously. To accomplish this the intelligence operator 102 may need to update the persona profile data for one or more personas as any given persona evolves over time. Referring now to FIG. 3, the persona management module 100 may be configured to display over the user device a persona management screen 300 configured to allow a given intelligence operator 102 access to any personas 104 actively controlled by that intelligence operator 102. This may allow the intelligence operator 102 to update the persona biographic data to include any new data or changes to existing data. In one embodiment, the persona management screen 300 may include data entry fields to allow the intelligence operator 102 to add new platforms 106 and/or aliases associated with the persona 104 since the persona profile data was originally entered into the persona management module 100.

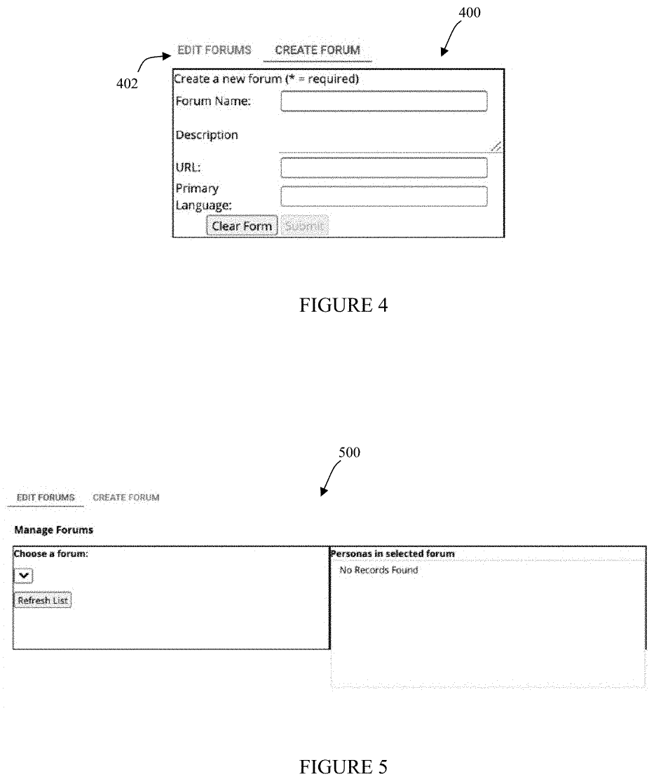

For example, with reference now to FIGS. 3-5, creating an online presence may require the intelligence operator 102 to create user accounts on one or more online platforms 106, each requiring a username and password. The intelligence operator 102 may be allowed to add this data to the existing persona profile data for ease of access and tracking capability. For example, and with particular reference to FIGS. 3 and 4, the intelligence operator 102 may be allowed to access a platform data screen 400 configured to create a new platform 106 for a given persona 104 by clicking on an “Add” button 302 on the persona management screen 300. In addition to a username and password, the persona profile data may include platform specific information that is required for the persona 104. For example, a given persona 104 may have accounts on multiple platforms 106. Each platform 106 may have different requirements such as language used, whether the platform 106 is public or private, or limitations on what the persona 104 may discuss on the platform. Users may also be able to select an “Edit Forums” link 402 to access a forum editing screen 500 that may allow users to update any existing information.

The collection of this information improves the ability of the intelligence operator 102 to function across multiple platforms 106 while also improving the transition process if one intelligence operator 102 is replaced by another. The new intelligence operator 102 may quickly access all of the collected information for a given persona 104 from a limited number of screens without needing to sort through randomly collected notes stored on paper, across multiple databases or computer systems, or needing to search for untracked data.

The persona management module 100 may also be configured to display to the intelligence operator 102 a list of all personas 104 with an account on a given platform 106. A platform management screen 300 may also allow the intelligence operator 102 to see or search for other personas 104 on a given platform 106 thereby allowing the intelligence operator 102 to quickly identify or distinguish existing personas 104 from intelligence targets 108.

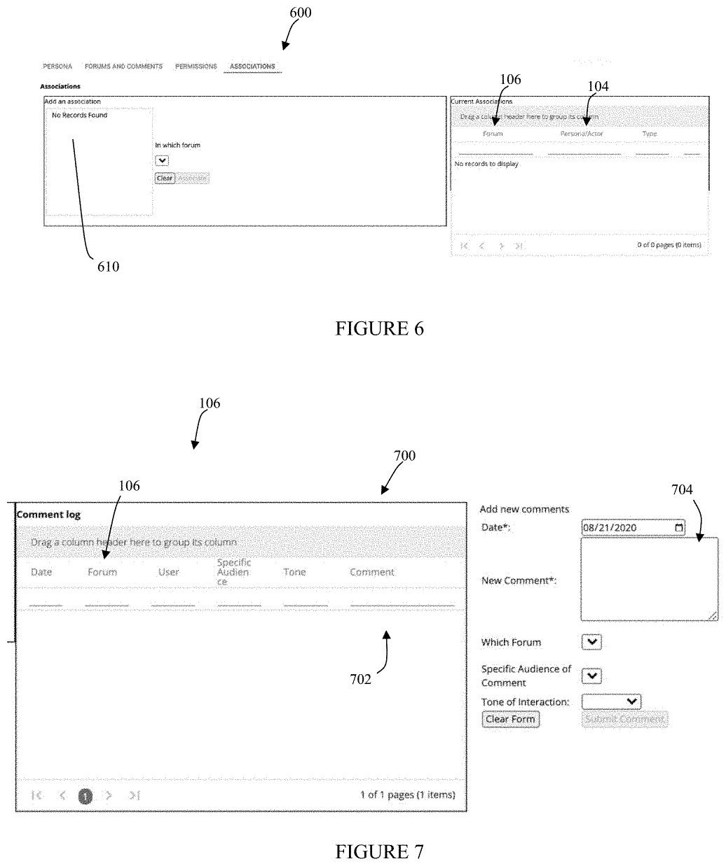

Referring now to FIG. 6, the persona management module 100 may also be configured to track specific intelligence targets 108 and automatically create links between commonalities associated with intelligence targets 108 and personal profile data such as: any known associates 610 of intelligence targets 108; contacts between personas 104 and intelligence targets 108; and platforms 106 common between intelligence targets 108 and personas 104. For example, an intelligence operator 102 may be allowed to enter an intelligence target 108, or association, into an association screen 600 of the persona management module 100 for tracking. Data associated with the intelligence target 108 may include which platform(s) 106 they are using, who they are associated with, and what kind of contact they are. The persona management module 100 may then access this information to create maps between the newly entered data and stored data to allow the data to be presented in a visual manner including links 110 that allow users of the system to quickly and easily identify any identified links 110 or commonalities between various aspects of persona profile data and other known about identified intelligence targets 108.

The intelligence operator 102 may also be able to enter or keep track of previous comments 702 they leave on various platforms 106 via the personas 104 they manage or comments made by one or more intelligence targets 108. For example, referring now to FIG. 7, persona management module 100 may comprise a comment entry screen 700 that allows the intelligence operator 102 to enter new comments 704 generated by personas 104 on a platform 106 or communication forum. Alternatively, the persona management module 100 may be configured to automatically monitor and store comments made by the intelligence operator 102 while using a persona 104. Stored comments may be reviewed later by the intelligence operator 102 or any other person having access to the persona management module 100.

The persona management module 100 may also be configured to analyze stored data to search for any desired criteria such as potential threats, trends, activities of intelligence targets 108, planned meetings, and the like. The persona management module 100 may also be configured to communicate with other systems. For example, collected data may be uploaded or otherwise communicated to a linked intelligence management system to facilitate improved tracking or enhanced traceability of specific requirements.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Although embodiments of the present technology have been described with reference to databases, the technology should not be viewed as being limited in that respect. As would be familiar with one of ordinary skill in the art after becoming familiar with the teachings of the present technology, the subject matter could also be used with any storage device for storing multiple types of data from one or more sources.

Although existing methods of managing online personas may separately include some discrete aspects of the technology, they do not include all the features and do not provide them in visual manner directed towards more efficient communication of particular aspects of stored data to a user. In addition, while some systems may offer a technology integration between different platforms, this at best can only approximate a combined technology, along with the increased costs and complexity that comes with paying for and managing multiple platforms, devices and access credentials. Similarly, existing solutions typically depend on brute force methods of manipulating saved data, which is cumbersome and time-consuming for users.

The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the components and/or elements recited in any apparatus embodiment may be assembled or otherwise operationally configured in a variety of permutations to produce substantially the same result as the present technology and are accordingly not limited to the specific configuration recited in the specific examples.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to exemplary embodiments. However, changes and modifications may be made to the exemplary embodiments without departing from the scope of the present technology. These and other changes or modifications are intended to be included within the scope of the present technology, as expressed in the following claims.

1. A method for managing a plurality of intelligence personas implemented by a computer operated by a user and having a processor, a display device, and a database, comprising:
using a persona management module to store a plurality of persona profiles into the database according to data entered by the user, wherein each persona profile corresponds to a unique intelligence persona stored in the database; and
using a visualization module to:
retrieve at least a portion of the plurality of persona profiles from the database according to a user selected preference;
convert the retrieved portion of persona profiles into a relationship diagram, wherein the relationship diagram comprises:
a data tree for each intelligence persona stored in the database;
a set of visual cues indicating commonalities between any persona profiles contained in the relationship diagram; and
display the relationship diagram to the user on the display device in a visual based format.

2. A method for managing a plurality of intelligence personas according to claim 1, wherein the persona profile for each intelligence persona in the database comprises:
an identified operator of the intelligence persona;
a set of unique personally identifiable information corresponding to the intelligence persona; and
at least one information target of the intelligence persona; and
a list of communication platforms used by the intelligence persona to communicate with the at least one information target.

3. A method for managing a plurality of intelligence personas according to claim 2, wherein the data tree for each intelligence persona stored in the database comprises a visual depiction of the set of persona data showing:
the identified operator;
any other intelligence personas controlled by the identified operator;
each communication platform used by the intelligence personas; and
which information target associated with a particular intelligence persona uses a given communication platform.

4. A method for managing a plurality of intelligence personas according to claim 3, wherein commonalities between any intelligence personas contained in the relationship diagram comprises a relationship between any information targets shown in the data tree.

5. A method for managing a plurality of intelligence personas according to claim 1, wherein the displayed by the relationship diagram is configured to be interactive allowing the user to selectively obtain more detailed information of any displayed data.

6. A network-enabled intelligence persona management system accessible by a user device, comprising:
a persona management module communicatively coupled to the network-enabled intelligence persona management system for storing a plurality of persona profiles in a database, wherein each persona profile corresponds to a unique intelligence persona stored in the database; and
a visualization module communicatively linked to the persona management module, the database, and the user device, wherein the persona management module is configured to:
retrieve at least a portion of the plurality of persona profiles from the database according to a user selected preference;
convert the retrieved portion of persona profiles into a relationship diagram, wherein the relationship diagram comprises:
a data tree for each persona stored in the database;
a set of visual cues indicating commonalities between any persona profiles contained in the relationship diagram; and
display the relationship diagram to the user on the display device in a visual based format.

7. A network-enabled intelligence persona management system according to claim 6, wherein the persona profile for each intelligence persona in the database comprises:
an identified operator of the intelligence persona;
a set of unique personally identifiable information corresponding to the intelligence persona; and
at least one information target of the intelligence persona; and
a list of communication platforms used by the intelligence persona to communicate with the at least one information target.

8. A network-enabled intelligence persona management system according to claim 7, wherein the data tree for each intelligence persona stored in the database comprises a visual depiction of the set of persona data showing:
the identified operator;
any other intelligence personas controlled by the identified operator;
each communication platform used by the intelligence personas; and
which information target associated with a particular intelligence persona uses a given communication platform.

9. A network-enabled intelligence persona management system according to claim 8, wherein commonalities between any intelligence personas contained in the relationship diagram comprises a relationship between any information targets shown in the data tree.

10. A network-enabled intelligence persona management system according to claim 6, wherein the displayed the relationship diagram is configured to be interactive allowing the user to selectively obtain more detailed information of any displayed data.

11. An internet based intelligence persona management system accessible by a user device connected to the internet via a network, comprising:
an internet based storage medium communicatively coupled to the user device, wherein the internet based storage medium is configured to store a plurality of intelligence personas;
a persona management module communicatively coupled to the internet based storage medium and the user device and configured to cause a plurality of persona profiles to be stored on the internet based storage medium according to data entered from the user device, wherein each persona profile corresponds to a unique intelligence persona from the plurality of intelligence personas stored in the internet based storage medium; and
a visualization module communicatively linked to the persona management module, a database, and the user device, wherein the persona management module is configured to:
retrieve at least a portion of the plurality of persona profiles from the database according to a user selected preference;
convert the retrieved portion of persona profiles into a relationship diagram, wherein the relationship diagram comprises:
a data tree for each persona stored in the database;
a set of visual cues indicating commonalities between any persona profiles contfained in the relationship diagram; and
display the relationship diagram to the user on the display device in a visual based format.

12. An internet based intelligence persona management system according to claim 11, wherein the persona profile for each intelligence persona in the database comprises:
an identified operator of the intelligence persona;
a set of unique personally identifiable information corresponding to the intelligence persona; and
at least one information target of the intelligence persona; and
a list of communication platforms used by the intelligence persona to communicate with the at least one information target.

13. An internet based intelligence persona management system according to claim 12, wherein the data tree for each intelligence persona stored in the database comprises a visual depiction of the set of persona data showing:
the identified operator;
any other intelligence personas controlled by the identified operator;
each communication platform used by the intelligence personas; and
which information target associated with a particular intelligence persona uses a given communication platform.

14. An internet based intelligence persona management system according to claim 13, wherein commonalities between any intelligence personas contained in the relationship diagram comprises a relationship between any information targets shown in the data tree.

15. An internet based intelligence persona management system according to claim 11, wherein the displayed by the relationship diagram is configured to be interactive allowing the user to selectively obtain more detailed information of any displayed data.
